(19) United States
(12) Patent Application Publication
(10) Pub. No.: US 2025/0258194 A1
(43) Pub. Date: Aug. 14, 2025

(54) METHOD FOR EVALUATING A MOVEMENT OF A WEARABLE DEVICE AND A WEARABLE DEVICE

(71) Applicant: Robert Bosch GmbH, Stuttgart (DE)

(72) Inventors: Carl Hammarlund, Malmö (SE); Federico Wadehn, Winterthur (CH); Karl Wiklund, Reutlingen (DE); Rudolf Bichler, Eningen (DE)

(21) Appl. No.: 19/041,218

(22) Filed: Jan. 30, 2025

(30) Foreign Application Priority Data
Feb. 9, 2024 (DE) 10 2024 201 168.1

(51) Int. Cl. G01P 15/18; G01P 13/00

(52) U.S. Cl. CPC G01P 15/18; G01P 13/00

(57) ABSTRACT

A method for evaluating a movement of a wearable device. The method includes acquiring first sensor data describing a three-dimensional acceleration vector; acquiring second sensor data describing a three-dimensional rotation rate vector; and acquiring a corresponding timestamp indicative of a time at which the first and second sensor data were acquired. The acquisition of the first and second sensor data and the timestamp are performed periodically for a plurality of successive points in time. The method includes a step of performing kinematic signal processing for the first and second sensor data with a strapdown integration for calculating a position, a velocity, and an acceleration for each point in time. The strapdown integration is performed using an attenuation factor.

### CROSS REFERENCE

The present application claims the benefit under 35 U.S.C. § 119 of German Patent Application No. DE 10 2024 201 168.1 filed on Feb. 9, 2024, which is expressly incorporated herein by reference in its entirety.

### FIELD

The present invention relates to a method for evaluating a movement of a wearable device and a wearable device.

### BACKGROUND INFORMATION

In order to improve in a particular sport, it is important to be aware of and improve movement aspects (velocity, timing, etc.) as well as to receive prompt feedback. The first step is accurate motion analysis. Motion analysis in sports is traditionally based on optical systems for sensing motion using high-speed cameras. However, such systems require a fixed construction, are restricted to a limited space, and are expensive, see, e.g., E. van der Kruk et al.: “Accuracy of human motion capture systems for sport applications; state-of-the-art review” European Journal of Sport Science 18.6 (2018): 806-819.

As such, wearable devices such as smartwatches or smartphones (“wearables”) have evolved over the past few years as popular devices for motion recording and evaluation when playing sports. Wearable devices are typically equipped with a plurality of MEMS sensors, including inertial measurement units (IMU) for measuring acceleration and angular velocity, magnetometers, and pressure sensors. Thanks to increasingly powerful embedded processors on the IMU or the wearable device, raw signals from the IMU for gesture detection, orientation processing, pedestrian navigation and many other use cases can be evaluated and further processed. IMUs, in particular in combination with magnetometers, may be used to estimate kinematic signals such as the acceleration and velocity of a moving body part of a user.

Velocity or its properties, such as the uniformity, duration of the static phases, maximum velocity, repeatability of a particular movement and the like, are of great importance for evaluating movements in disciplines such as Nordic walking, boxing, katas in martial arts or racket sports, such as tennis or golf.

Velocity tracking and position tracking based on simple strapdown integration of IMU data (i.e., acceleration and angular velocity in the frame of reference of the device) often suffers from a drift and is therefore usually accurate only over short distances and time periods. Multiple solutions to the drift problem have been proposed in the literature, which is due to the single integration to ascertain velocity or the dual integration to ascertain position, see, e.g., D. Titterton et al. “Strapdown inertial navigation technology” Vol. 17 IET (2004).

One approach is sensor fusion, in which estimations obtained from the processing of the IMU data are combined with other measured parameters using a Kalman filter, for example. For example, magnetometers may be used to correct a course deviation and determine the true north direction. Pressure sensors may be helpful in reducing a perpendicular deviation by providing absolute or relative elevation estimates. Cameras may be used for a visual-inertial odometry. Further, GNSS (“global navigation satellite system”) information may be used to correct position estimates.

For example, PCT Patent Application No. WO 2021/229 460 A1 describes a device for measuring a sprinting velocity. The device includes at least one position and/or velocity sensor and an IMU sensor, each providing position data and/or velocity data and acceleration data.

Many movements that are of interest in sports such as yoga or tai chi, katas in martial arts or boxing are repeated in an approximate manner or are pseudo random (i.e., the trajectories are difficult to predict) and have a long duration. Tracking such movements with simple strapdown integration methods often results in velocity estimates drifting or having inappropriately large values, even with well-calibrated sensors.

Unlike, for example, when jogging or cycling, there are frequent changes in direction during the above-named movements, and the direction is not readily predictable, so that it would be difficult to make use of movement restrictions (straight movements, a particular sequence of movements as in a golf swing, etc.), and doing so would result in an algorithm that would only be tailored to a few types of movement.

Translational movements of the entire body, e.g., due to footwork in martial arts, would result in human body models becoming inaccurate in combination with purely orientation-based approaches. One conventional approach to addressing such problems, for example, is to complete a periodical hard zeroing out of the velocity, although this can, however, lead to jumps in the velocity signal.

There is thus a need for a reliable and computationally simple method for evaluating IMU data of a wearable device in the case of repetitive and/or pseudo-random movements.

### SUMMARY

With the present invention, repetitive or pseudo-random movements can be detected and evaluated with high precision using a wearable device.

According to an example embodiment of the present invention, to estimate the (three-dimensional) velocity and further derived variables such as velocity magnitude or position from IMU signals of (quasi-) repetitive or pseudo-random sports movements, an (adaptive) velocity integration is provided, which can be combined with an adaptive position integration. Quasi-repetitive or pseudo-random movements have trajectories that are, for example, typically difficult to predict due to frequent changes in direction. Such changes in direction (almost) result in zero crossings in the velocity signals. The proposed velocity attenuation allows for a localized evaluation of the movement and advantageously leads to significantly lower deviations, since errors in acceleration are not reproduced due to attenuation of the three-dimensional velocity signals; instead, their effect is decreased with the attenuation.

The velocity attenuation according to an example embodiment of the present invention may also be combined with a position attenuation. This combined attenuation is suitable, for example, for modeling movements that are pseudo random and stationary, such as movements during yoga where the user does not move from their location.

According to an example embodiment of the present invention, therefore, a method for evaluating a movement of a wearable device and a wearable device are provided.

Advantageous embodiments and developments emerge from the disclosure herein.

The wearable device may preferably be a smartwatch, a smartphone, or a similar device, generally referred to as a “wearable.” According to preferred embodiments of the present invention, such a device can comprise a plurality of sensors, which can be manufactured, for example, by means of MEMS technology and can preferably be arranged on a board together with signal processing processors, memory chips and the like. Thus, particularly compact and lightweight wearable devices can be advantageously provided, which a user can wear when exercising, e.g., on the wrist or on another part of the body. Thus, the movements carried out in sports can be recorded and evaluated directly and with a high level of accuracy.

Further, according to an example embodiment of the present invention, the wearable device may preferably comprise a display device, such as a touch screen, and/or an audible output device for providing the user with acoustic and/or visual feedback.

Preferred sensors, which may be disposed in the wearable device, include at least one or multiple elements from the following list: an inertial measurement unit (“IMU”), accelerometer, rotation rate sensor, magnetometer, GPS sensor, pressure sensor, temperature sensor. For example, GPS data or magnetic field data may be used to match and, if necessary, correct estimated movement parameters (acceleration, velocity, position). This may further reduce the susceptibility to errors.

According to an example embodiment of the present invention, a preferred IMU combines an accelerometer and a rotation rate sensor, and may preferably output first sensor data describing a three-dimensional acceleration vector and second sensor data describing a three-dimensional rotation rate vector.

In order to make possible a temporal evaluation of generated sensor signals, the sensor data are generated in each case with a timestamp. For this purpose, the wearable device may preferably comprise a suitable timer. The sensor signals are periodically generated and sensed at a plurality of successive points in time. The points in time may preferably be indicated using an index k (whole number) to facilitate evaluation. A time period between two points in time may be referred to as a sampling period. The inverse of the sampling period indicates a sampling frequency. This may preferably be an order of magnitude of tens to hundreds to several thousand hertz.

To facilitate an evaluation of the generated sensor data, the sampling frequency can be adjusted as a function of a rate of change of the sensor signals. For example, it is advantageous to generate a large amount of data during fast movements in order to achieve the highest possible accuracy. In contrast, if there is no or only a slight change in the sensor signals, the sampling frequency may be reduced, thereby reducing the quantity of data to be processed. This may also conserve energy and storage space.

According to an example embodiment of the present invention, kinematic signal processing of the first and second sensor data is carried out. This means that the sensor data are evaluated to, for example, display and evaluate a trajectory of the movement of the wearable device in space. In particular, the trajectory of the wearable device is to be compared to a predetermined trajectory. For example, the sequence of movements carried out by a user during a sport may be compared to a desired motion sequence. By outputting acoustic and/or visual feedback, the user can detect in real time whether the movement was carried out correctly. This may improve a training effect, for example.

The kinematic signal processing includes a strapdown integration for calculating a position, a velocity, and an acceleration for each point in time. With corresponding strapdown IMU, the inertial sensors are preferably fixedly connected to an outer frame, e.g., a housing of the wearable device. Such an IMU preferably has three sensors for the rotation rates and accelerations relative to the three IMU axes. In the simplest case of linear movement in exactly one of these axes, the current (relative) position can be calculated comparatively easily, e.g., by two-fold integration of the acceleration to be continuously measured at a suitable sampling rate in the direction of movement. In the general case, on the other hand, accelerometers not only provide a signal for linear accelerations, but also have a signal fraction as a result of the rotational movement, which must be compensated for in order to determine the translational acceleration values. To this end, it is necessary to integrate the sensor signal values of the three rotation sensors and to use the information obtained in this way regarding orientation in space to calculate the linear acceleration values from measured values of the accelerometers.

Only after this calculation step can compensation for the value of gravitational acceleration be carried out for the acceleration values. This algorithm is called the strapdown algorithm.

In particular, as a result of the strapdown integration, a scalar velocity value and/or a three-dimensional velocity vector, a scalar acceleration value, and/or a three-dimensional acceleration vector and/or a three-dimensional position, preferably with respect to a fixed space coordinate system, can be generated and output. This makes it possible to present the movement data, for example for the user, in a clear manner. In preferred embodiments, it may be sufficient to output only scalar velocity values and acceleration values, for example, when analyzing a racket sport or the like.

According to an example embodiment of the present invention, the strapdown integration is performed using an attenuation factor. The attenuation factor may advantageously prevent a drift of the velocity and/or position, in particular in repetitive and/or pseudo-random movements.

According to a preferred configuration of the present invention, the kinematic signal processing comprises a first step for compensating for deviations and/or sensitivity errors of the sensed first and second sensor data. This step may comprise, for example, a calibration of the sensors or the IMU. Further, preferably in this step, a correction factor or the like ascertained during a calibration operation may be applied to the sensor data. Further, in the first step, the first sensor data may be compensated for by the value of the gravitational acceleration. As a result of the first step, corrected first and second sensor data may be output for further processing.

According to a preferred configuration of the present invention, the kinematic signal processing comprises a second step for merging the corrected first and second sensor data with a complementary filter and ascertaining an orientation of the wearable device with respect to a fixed space coordinate system.

According to a preferred configuration of the present invention, the kinematic signal processing comprises a third step of converting the first sensor data depending on the orientation. As a result of the third step, a converted acceleration vector may be output with reference to the fixed space coordinate system. This converted acceleration vector may then be further processed. Thus, calculations may be carried out using acceleration vectors in a fixed space world coordinate system in an advantageous manner.

According to a preferred configuration of the present invention, the kinematic signal processing comprises a first integration of the converted acceleration vector to generate a converted velocity vector and a second integration of the converted acceleration vector to generate a converted position vector.

According to a preferred embodiment of the present invention, the attenuation factor is applied to the converted velocity vector.

According to a preferred embodiment of the present invention, the attenuation factor is applied individually to each component of the converted velocity vector. Correspondingly, the attenuation factor may be, for example, a three-dimensional vector. This can, for example, make it possible for the attenuation factor to have a stronger effect along a predetermined axis than in a plane perpendicular to it. Thus, the deviation can in particular be reduced even more efficiently when the movement takes place substantially in a plane. The predetermined axis may preferably be a perpendicular axis parallel to the direction of gravity.

According to a preferred embodiment of the present invention, an attenuated velocity vector v[k+1] of a second discrete point in time k+1 is calculated after a first point in time k using the formula:

$$v [ k + 1 ] = γ [ k ] ∘ v [ k ] + a [ k ] \cdot Δ T ,$$

Here, v[k] is a velocity vector of the first point in time k, γ[k] the attenuation factor of the first point in time k, a[k] the acceleration vector of the first point in time k and ΔT is a sampling period, e.g., given by the time period between k and k+1.

According to a preferred embodiment of the present invention, the attenuation factor may be time dependent. For example, the attenuation factor may preferably be either on or off. In other words, there may either be little to no attenuation, e.g., at the beginning of a movement, and then more attenuation later on. Thus, deviations that occur, e.g., at the end or at the beginning of a motion sequence, can be suppressed particularly efficiently.

According to a preferred embodiment of the present invention, the attenuation factor may take on a value in the range]0, 1]. The zero is hereby excluded from the range for the attenuation factor in order to avoid a hard setting to zero, since this can result in jumps in the ascertained velocity trajectory, which are preferably to be avoided.

According to a preferred embodiment of the present invention, the attenuation factor may be stronger along a predetermined axis in a fixed space than in a plane perpendicular to the predetermined axis. In particular, the predetermined axis may be parallel to the force of gravity. This may be advantageous because a large group of movements are carried out parallel to the ground. Thus, a deviation due to minor velocity components in the direction of the predetermined axis may be efficiently reduced, in particular.

According to a preferred embodiment of the present invention, a further attenuation factor may be used for the position determination if the movement is presumed to take place largely in a stationary position. Similar to the modified velocity calculation, the three-dimensional position p[k] at the point in time k may be calculated as follows

$$p [ k + 1 ] = {γ}_{p} ∘ p [ k ] + v [ k ] Δ T$$

Here, γₚ∈ [symbol] ³ is a three-dimensional attenuation factor, the [symbol] elements of which assume values between 0 and 1. This equation results in the position being drawn to the origin [0,0,0], and thus a slightly drifted position may be corrected again.

A preferred method of the present invention includes a step of outputting an acoustic and/or visual signal as a function of a deviation between the calculated position and/or velocity and/or acceleration and a position and/or velocity and/or acceleration of a predetermined motion sequence. This may advantageously assist the user in learning, practicing, and/or improving a motion sequence. Such a wearable device can thus serve as a human-machine interface that allows for a technical evaluation of a movement, wherein feedback is provided to the user in real time. The present invention thereby advantageously links movement in real space with a predetermined ideal movement in virtual space and allows the user to detect the deviation measured by technical means (sensors) using of acoustic and/or visual signals.

Preferably, according to an example embodiment of the present invention, a volume and/or a frequency of the acoustic signal may be modulated depending on the deviation. By using an acoustic signal, the user can better focus on performing the movement without needing to look at a display.

Further, preferably, a brightness and/or a color of the visual signal may be modulated depending on the deviation. This visual signal may preferably be output on an external display so that the user may more easily see the visual signal. However, a modulation of the brightness or the color of a display can also be easily perceived by the user in their peripheral field of vision, so that the visual feedback is perceived by the user while they are performing the movement. Visual feedback may also be advantageously perceived in noisy environments.

A preferred sonication, i.e., conversion of a physical variable into sound, may be used to output a (quasi) real-time feedback for sports movements, as described above. Other than in certain applications such as fitness centers with screens in front of fitness equipment or with augmented reality glasses, the user typically does not receive any immediate visual feedback about their movements. However, converting movement aspects, such as velocity, into sounds can provide real-time feedback and allows the user to utilize that feedback to improve certain movement aspects.

According to an example embodiment of the present invention, a wearable movement evaluation device comprises a first sensor for generating first sensor data, a second sensor for generating second sensor data, and a processor for acquiring the first and second sensor data. The first sensor, second sensor, and processor may particularly preferably be designed as embedded IMUs or as separate devices.

The processor of the wearable device is configured in accordance with the present invention to perform a method according to the present invention.

The present invention is explained in greater detail below with reference to the embodiment examples indicated in the schematic figures.

### BRIEF DESCRIPTION OF THE DRAWINGS

FIG. 1 shows a flow chart of an evaluation of sensor signals of an IMU, according to an example embodiment of the present invention.

FIG. 2 shows a test set-up in which a wearable device is suspended as a pendulum at a fixed point, according to an example embodiment of the present invention.

FIG. 3A shows the ascertained position of the wearable device in FIG. 2 evaluated using a conventional method.

FIG. 3B shows the ascertained position of the wearable device in FIG. 2 evaluated using a method according to an embodiment example of the present invention.

FIG. 4A shows the estimated three-dimensional velocity of the wearable device in FIG. 2 and a velocity magnitude evaluated using a conventional method.

FIG. 4B shows the estimated three-dimensional velocity of the wearable device in FIG. 2 and a velocity magnitude evaluated using a method according to an embodiment example of the present invention.

FIG. 5A shows a circular path evaluated using a conventional method.

FIG. 5B shows a circular path evaluated using a method according to an embodiment example of the present invention.

FIG. 6A shows an estimated velocity of the circular path in FIG. 5A ascertained by way of dead reckoning without attenuation of the velocity.

FIG. 6B shows an estimated velocity of the circular path in FIG. 5A ascertained by dead reckoning navigation with attenuation of the velocity.

FIG. 7 shows a comparison of simulated acceleration, velocity, and position with exponential velocity attenuation.

FIG. 8 shows sensor data on acceleration, angular velocity, velocity, and position.

FIG. 9 shows an evaluated circular path during a motion sequence while golfing.

### REFERENCE NUMBER LIST

1 IM
2 middle processing block
3 output
4 orientation processing
5 dead reckoning
S1 first sensor data
S2 second sensor data
K1 acceleration calibration
K2 rotation rate (angular velocity) calibration
s position
v speed
a acceleration

### DETAILED DESCRIPTION OF EXAMPLE EMBODIMENTS

The accompanying figures are intended to provide a better understanding of the embodiments of the present invention. They illustrate embodiments and, in connection with the description, serve to explain principles and concepts of the present invention. Other embodiments and many of the mentioned advantages become apparent from the drawings. The elements of the drawings are not necessarily shown to scale with respect to one another.

In the figures of the drawing, identical, functionally identical, and identically acting elements, features and components, are each shown with the same reference numbers, unless otherwise stated.

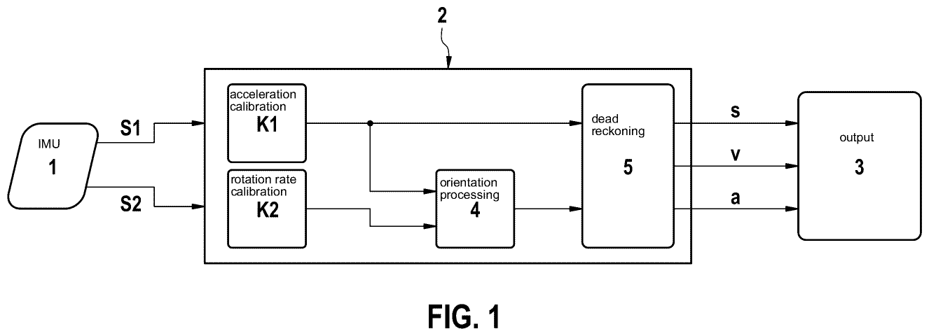

FIG. 1 shows a flow chart of a method for evaluating sensor signals of an IMU. The IMU is disposed in a wearable device and measures acceleration (first sensor data) and angular velocity (second sensor data) relative to a coordinate system of the wearable device.

As shown in FIG. 1, the IMU 1 outputs first sensor data S1 (describing a three-dimensional acceleration vector) and second sensor data S2 (describing a three-dimensional rotation rate vector). These sensor data are processed in multiple steps in the middle block 2 of the flow chart.

First, the data are compensated for or corrected based on a calibration of the acceleration (K1) or rotation rate (or angular velocity) (K2) such that distortion errors and sensitivity errors can be reduced or largely eliminated.

These corrected first and second sensor data are then fused, e.g., with a complementary filter, to obtain the orientation of the wearable device. In a given orientation, a strapdown integration of the corrected sensor data may be performed by rotating the first sensor data (acceleration) measured by the IMU in the coordinate system of the wearable device into a fixed space coordinate system (also referred to as the world coordinate system). This operation is referred to as orientation processing (4) in FIG. 1.

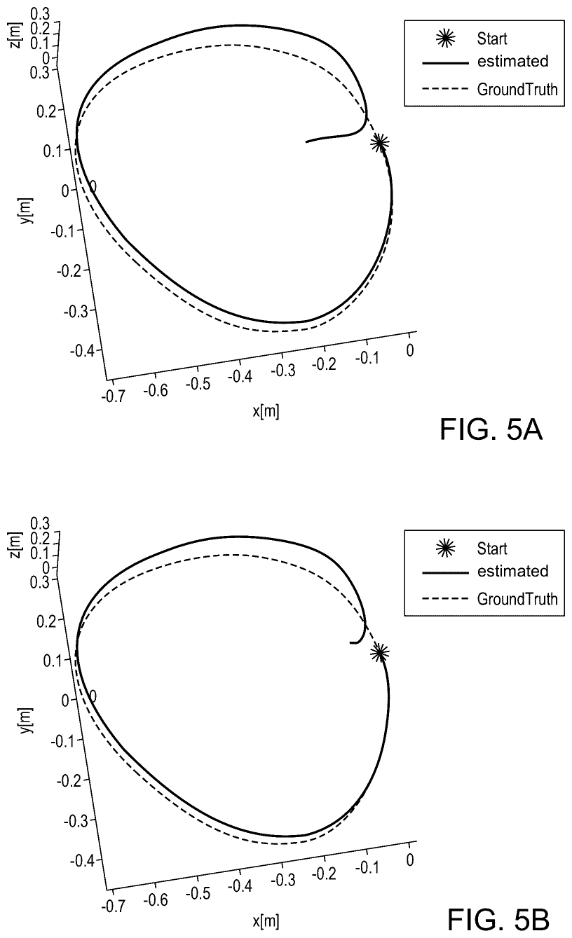

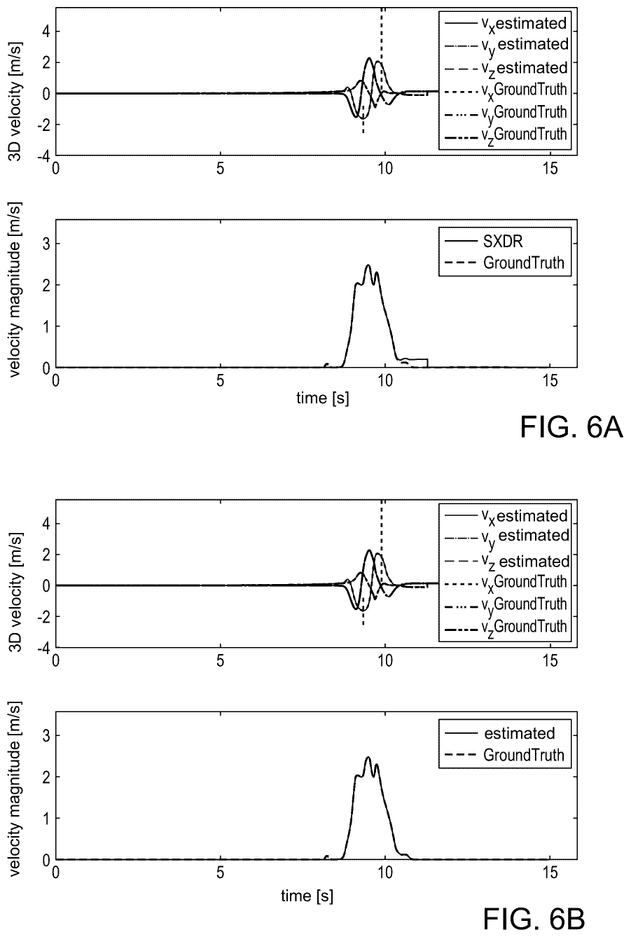

Then, the acceleration signal is integrated once to obtain the velocity and twice to determine the relative position (see FIG. 6B and FIG. 5B, respectively).

The middle block in the flowchart of FIG. 1 is for estimating kinematic signals and calculates the position s, velocity v, and acceleration a of the wearable device relative to the fixed space coordinate system. For example, these kinematic signals, in particular the velocity, can be used to provide visual or acoustic feedback to the user. For this purpose, the kinematic signals can be compared to a predetermined motion sequence. The acoustic or visual feedback can, for example, be modulated as a function of a deviation from the predetermined motion sequence.

The kinematic signal processing in the middle block comprises a method according to dead reckoning (5). Here, the location determination of the moving object (the wearable device) is calculated based on the last calculated location and an ascertained direction of movement (path) and velocity. This is thus an iterative method in which errors can be continuously reproduced. However, by implementing velocity attenuation, the effects of a deviation in velocity can be significantly reduced.

In the strapdown integration, after orientation processing, the acceleration is rotated into the world coordinate system and then numerically integrated. The attenuated velocity integration is in the form of

$$v [ k + 1 ] = γ [ k ] ∘ v [ k ] + a [ k ] \cdot Δ T ,$$

Here, v[k+1] is the velocity vector of a second point in time k+1 after a first point in time k, v[k] is a velocity vector of the first point in time, γ[k] is the attenuation factor of the first point in time, a[k] is the acceleration vector of the first point in time, and ΔT is a sampling period. In the formula, ∘ denotes the element-based product.

The reason for the attenuation is that the velocity is pushed to zero over time unless there is significant acceleration along a particular axis that compensates for this. This allows for localized analysis of movement with significantly less drift and no unduly large velocity estimates. An error in the acceleration signal does not continue to reproduce, but rather subsides due to attenuation.

In addition, with repeated or pseudo-random movements, as in the case of a pendulum described below, there are typically zero crossings of velocity, e.g., due to changes in direction, while then regaining velocity by re-acceleration in a particular direction. This movement characteristic is quite well approximated by the velocity attenuation.

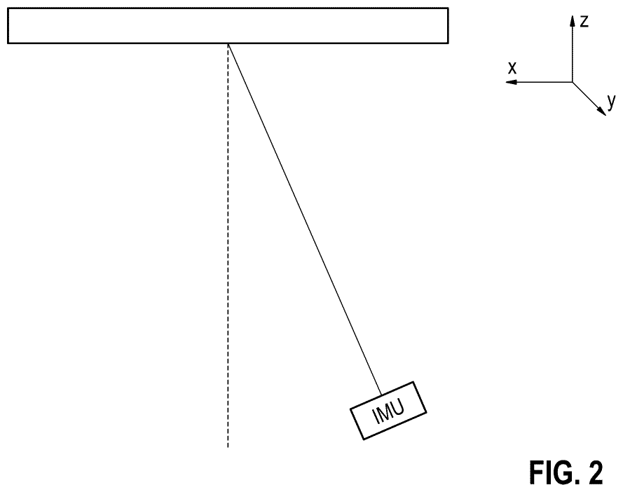

FIG. 2 shows a test set-up in which a portable device with an IMU as a pendulum is suspended at a fixed point. The pendulum is deflected against the center position and the IMU outputs corresponding first and second sensor data for the resulting movement, which are evaluated. In the following, the results using a conventional method are compared to a method according to the present invention. For reference, FIG. 2 shows a three-dimensional, fixed-space Cartesian coordinate system with axes x, y, z.

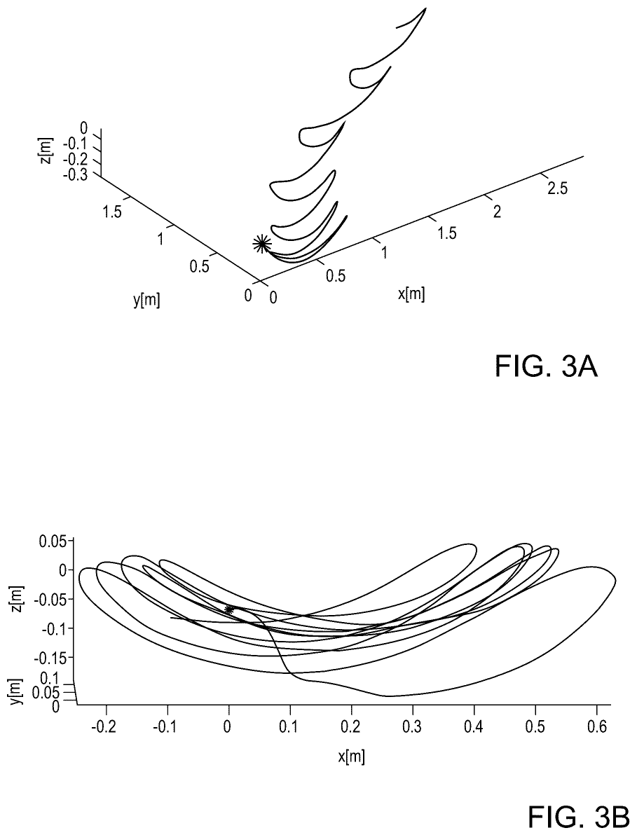

FIG. 3A illustrates a temporal course of the ascertained position of the wearable device in the test set-up of FIG. 2, which was evaluated using a conventional method. The starting point of the movement is marked with a star. As can be clearly seen, the position drifts away from the initial position after only a few oscillations.

FIG. 3B illustrates a temporal course for the ascertained position of the wearable device in the test set-up of FIG. 2 evaluated using a velocity attenuation method according to an embodiment example. The starting point of the movement is marked with a star. Unlike FIG. 3A, no significant drifting of the position is observed here.

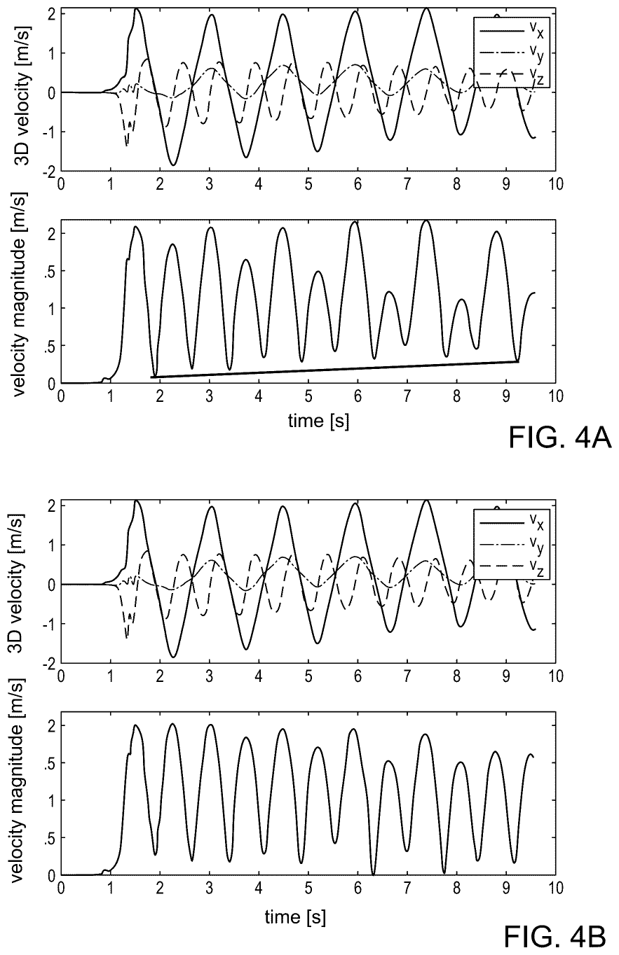

FIG. 4A, corresponding to FIG. 3A, illustrates a temporal course for the estimated three-dimensional velocity (upper curve) of the wearable device in FIG. 2 and the velocity magnitude (lower curve) evaluated using a conventional method. The velocity magnitude has a distinct upward trend leading to the large deviations of position in FIG. 3A.

FIG. 4B illustrates, corresponding to FIG. 3B, a temporal course for the estimated three-dimensional velocity (upper curve) of the wearable device in FIG. 2 and the velocity magnitude (lower curve) evaluated using a method according to an embodiment example. Compared to FIG. 4A, the course of the velocity magnitude has a relatively low drift.

The example of FIGS. 2 to 4B shows how the method according to the present invention can avoid long-term drift with velocity attenuation. Further, according to a further development, a greater velocity attenuation may be employed towards the end of a movement. For example, if the rotation rate is low (for a certain period of time) and the measured acceleration is close to gravitational acceleration, the wearable device is very likely to be static or move very slowly.

In contrast to a zero-velocity update method that would set the velocity to zero, the preferably exponential attenuation of the velocity has a less catastrophic effect on false positives (i.e., falsely triggered zero-velocity updates during the movement), see, e.g., J. Wahlstram et al. “Fifteen years of progress at zero velocity: A review” IEEE Sensors Journal 21.2 (2020): 1139-1151.

If the estimated residual velocity is great after stopping the movement and stopping in the real world, a large deviation may occur, such as in FIG. 5B at the end of the movement. With a velocity attenuation that starts earlier than a zero-velocity update, the deviation can be significantly reduced, see FIG. 5A.

FIG. 5A illustrates a circular path evaluated using a conventional method without velocity attenuation (solid line). Such a trajectory may be observed, for example, during a tee shot when playing golf. The starting point of the movement is marked with a star. The dashed line indicates a circular path captured by a recording system comprising twelve cameras, referred to as “ground truth.” Due to a residual velocity at the end of the movement, a large deviation (outlier/swerve at the end of the movement) is caused in the evaluated circular path.

FIG. 5B illustrates, similar to FIG. 5A, a circular path that was evaluated using a method according to an embodiment example (solid line). The ground truth shown corresponds to FIG. 5A. However, unlike FIG. 5A, FIG. 5B shows only a very slight deviation at the end of movement. The use of velocity attenuation can thus reduce the deviation.

FIG. 6A illustrates an estimated velocity of the circular path of FIG. 5A ascertained by way of dead reckoning without attenuation of the velocity. The upper curve illustrates the three-dimensional velocity (components in x, y, z-direction) and the lower curve illustrates the magnitude of the velocity. At the end of the movement, a small residual velocity remains for a long period of time, which causes the deviation observed in FIG. 5A. At the very end, the velocity is set to zero via a zero-velocity update.

FIG. 6B, similar to FIG. 6A, illustrates an estimated velocity of the circular path in FIG. 5A ascertained by dead reckoning with attenuation of the velocity. When the actual movement is over, the velocity and rotation rate of the device are low, and the attenuation reduces the velocity to zero. Thus, the deviation can be significantly reduced at the end.

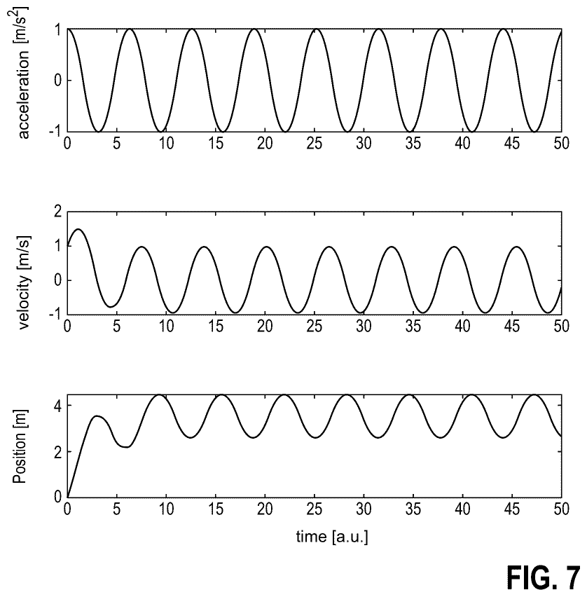

FIG. 7 illustrates a comparison between a temporal course of an acceleration simulated by cos function (top), an attenuated velocity with exponential velocity attenuation and an initial velocity of 1 m/s (middle), and a position ascertained by velocity integration (bottom). Even if the actual movement had an initial velocity of zero and if an initial velocity of 1 m/s was incorrectly assumed, the velocity error would be quickly compensated for by the exponential velocity attenuation and would no longer distort the estimates even after an extended period of time.

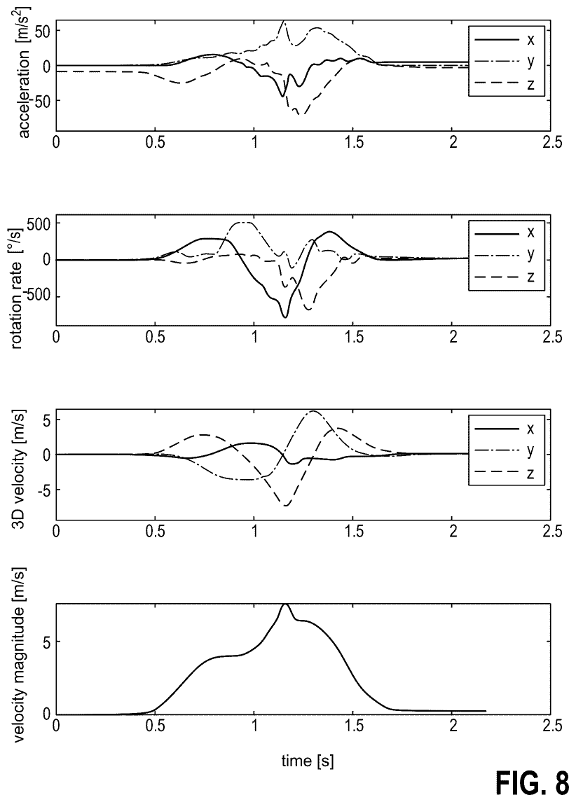

FIG. 8 illustrates sensor data for acceleration, angular velocity, velocity, and the position of an IMU. The top plot shows the raw three-dimensional acceleration signals in the coordinate system of the device. The second plot shows the raw three-dimensional rotation rate signals in the coordinate system of the device. The third plot shows the velocity components in the world coordinate system and the bottom plot illustrates the ascertained magnitude of the velocity.

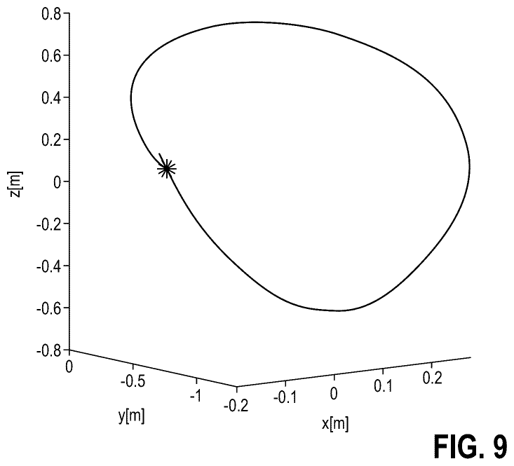

FIG. 9 illustrates an evaluated circular path during a motion sequence while playing golf.

In the present invention, multiple features have been designated “first” and “second.” These designations are only used to clearly differentiate the individual features. In particular, no spatial or functional placement or prioritization is to be derived therefrom.

If a list of alternatives is provided with the designation “or” in the present application, it should be understood both that the listed alternatives should be taken on their own and also, if reasonable, a combination of multiple or all listed alternatives should be understood.

What is claimed is:

1. A method for evaluating a movement of a wearable device, comprising the following steps:
acquiring first sensor data describing a three-dimensional acceleration vector;
acquiring second sensor data describing a three-dimensional rotation rate vector;
acquiring a corresponding timestamp indicative of a time of acquiring the first sensor data and the second sensor data, wherein the acquisition of the first and second sensor data and the timestamp are carried out periodically for a plurality of successive points in time; and
performing kinematic signal processing of the first sensor data and the second sensor data with a strapdown integration to calculate a position, a velocity, and an acceleration for each point in time;
wherein the strapdown integration is performed using an attenuation factor.

2. The method according to claim 1, wherein the kinematic signal processing includes:
compensating for deviations and/or sensitivity errors of the acquired first and second sensor data; and
outputting corrected first and second sensor data.

3. The method according to claim 2, wherein the kinematic signal processing includes:
merging the corrected first and second sensor data with a complementary filter and ascertaining an orientation of the wearable device with respect to a fixed space coordinate system.

4. The method according to claim 3, wherein the kinematic signal processing includes:
converting the first sensor data depending on the orientation; and
outputting a converted acceleration vector with reference to the fixed space coordinate system.

5. The method according to claim 4, wherein the kinematic signal processing includes:
first integration of the converted acceleration vector to generate a converted velocity vector;
second integration of the converted acceleration vector to generate a converted position vector.

6. The method according to claim 5, wherein:
the attenuation factor is applied to the converted velocity vector; and/or
another attenuation factor is applied to the position vector.

7. The method according to claim 6, wherein the attenuation factor is applied individually to each component of the converted velocity vector.

8. The method according to claim 6, wherein an attenuated velocity vector v[k+1] of a second point in time k+1 is calculated after a first point in time k using the formula:
v[k+1]=γ[k]∘v[k]+a[k]·ΔT,
wherein v[k] is a velocity vector of the first point in time, γ[k] is the attenuation factor of the first point in time, a[k] is the acceleration vector of the first point in time, and ΔT is a sampling period.

9. The method according to claim 8, wherein:
the attenuation factor is time dependent; and/or
the attenuation factor assumes a value in the range of]0, 1]; and/or
the attenuation factor is stronger in the fixed space along a predetermined axis than in a plane perpendicular to the predetermined axis.

10. The method according to claim 1, further comprising:
outputting an acoustic and/or visual signal depending on a deviation between: (i) the calculated position and/or velocity and/or acceleration, and (ii) a position and/or velocity and/or acceleration of a predetermined motion sequence;
wherein: (i) a volume and/or a frequency of the acoustic signal is modulated depending on the deviation; and/or (ii) a brightness and/or a color of the visual signal are modulated depending on the deviation.

11. A wearable device for evaluating a movement, comprising:
a first sensor configured to generate first sensor data;
a second sensor configured to generate second sensor data; and
a processor configured to acquire the first and second sensor data, wherein the processor is configured to evaluate the movement of the wearable device, including the following steps:
acquiring the first sensor data, the first sensor describing a three-dimensional acceleration vector,
acquiring the second sensor data, the second sensor data describing a three-dimensional rotation rate vector,
acquiring a corresponding timestamp indicative of a time of acquiring the first sensor data and the second sensor data, wherein the acquisition of the first and second sensor data and the timestamp are carried out periodically for a plurality of successive points in time, and
performing kinematic signal processing of the first sensor data and the second sensor data with a strapdown integration to calculate a position, a velocity, and an acceleration for each point in time,
wherein the strapdown integration is performed using an attenuation factor.

12. The wearable device according to claim 11, further comprising:
an output device configured to output an acoustic signal and/or to output a visual signal.
